(19) United States
(12) Patent Application Publication
(10) Pub. No.: US 2018/0089271 A1
(43) Pub. Date: Mar. 29, 2018

(54) DATABASE QUERY CLASSIFICATION

(71) Applicant: HEWLETT PACKARD ENTERPRISE DEVELOPMENT LP, Houston, TX (US)

(72) Inventors: Ramakumar KOSURU, Austin, TX (US); Sati KAILASH, Sr., Bangalore (IN); Ravisha NEELAKANTHAPPA, Austin, TX (US)

(21) Appl. No.: 15/566,214

(22) PCT Filed: Jul. 28, 2015
(86) PCT No.: PCT/US2015/042506

§ 371 Date: Oct. 12, 2017

(30) Foreign Application Priority Data
Apr. 15, 2015 (IN) 1947/CHE/2015

(51) Int. Cl. G06F 17/30; G06N 99/00; G06N 5/02

(52) U.S. Cl. CPC G06F 17/30474; G06N 5/022; G06N 99/005

(57) ABSTRACT

A method for improving database query classification includes reducing a predetermined plurality of features, generated by an optimizer, to a learned model of features by using a machine learning method. Classification is performed based on features of the query and features of operators executed by the query. The method also includes assigning an execution classification to a query based on the learned model of features. The execution classification is associated with a timeout threshold for execution of the query.

### BACKGROUND

Accurate workload characterization is useful in meeting quality of service (QoS) goals in large scale database systems. Large scale database systems may be used opaquely, as in a cloud setting, or used more transparently in online transaction processing (OLTP) and decision support systems (DSS). Workload characterization typically means classifying a workload of database queries based on expected response times. Typical workload management tools use timeout thresholds for a query to complete based on the characterization; otherwise, the query may be aborted. As such, inaccurate classification wastes resources and limits how many queries can be executed, causing queue buildup, and resulting in a less robust computing system. In these computing environments, the ability to predict response times helps in managing the system. Workload management tools use workload characterization to prioritize queries, and to allocate resources. Currently, these tools use costs, estimated by the optimizer, to classify queries. However, when cost models change, or changes are made to cost calculations, the estimated costs change, and a workload management tool's classification logic also changes.

### BRIEF DESCRIPTION OF THE DRAWINGS

Certain examples are described in the following detailed description and in reference to the drawings, in which:

FIG. 1 is a block diagram of an example system for classifying database queries;

FIG. 2 is a process flow diagram of an example method for classifying database queries;

FIG. 3 is a process flow diagram of an example method for classifying queries;

FIG. 4 is a table representing an example of a PCA transformation in eight dimensions;

FIG. 5 is a process flow diagram of a method 500 for database query classification;

FIG. 6 is a block diagram of an example system for database query classification;

FIG. 7 is a block diagram of an example system for database query classification; and

FIG. 8 is a block diagram showing an example tangible, non-transitory, machine-readable medium that stores code for database query classification.

### DETAILED DESCRIPTION

Examples of the claimed subject matter classify database queries of a workload to improve Quality of Service (QoS) goals in a large-scale database environment. An augmented set of query plan data items is generated by a modified database optimizer; and, these additional data items are used to classify the queries. This differs from the current approach that relies solely on the estimated cost of a query for classification. Machine learning techniques are also used, which represents an improvement over the existing heuristic-based approaches.

SQL optimizers estimate the cost of a query using many variables such as, statistics of tables, selectivity of predicates, estimated number of input/outputs (I/Os), and estimated amount of memory used at runtime. Internally, SQL optimizers process a variety of plans before choosing the plan with the lowest cost for execution. However, identifying the plan with the lowest cost is challenging; and, the cost is merely an estimate. In some cases, the cost estimates may be incorrect, and the wrong plan may be selected. This may be due to a design limitation, or possibly, a defect in the optimizer engine code. Thus, because the estimated costs may be wrong, workload characterization may incorrectly classify database queries, causing a waste of database resources.

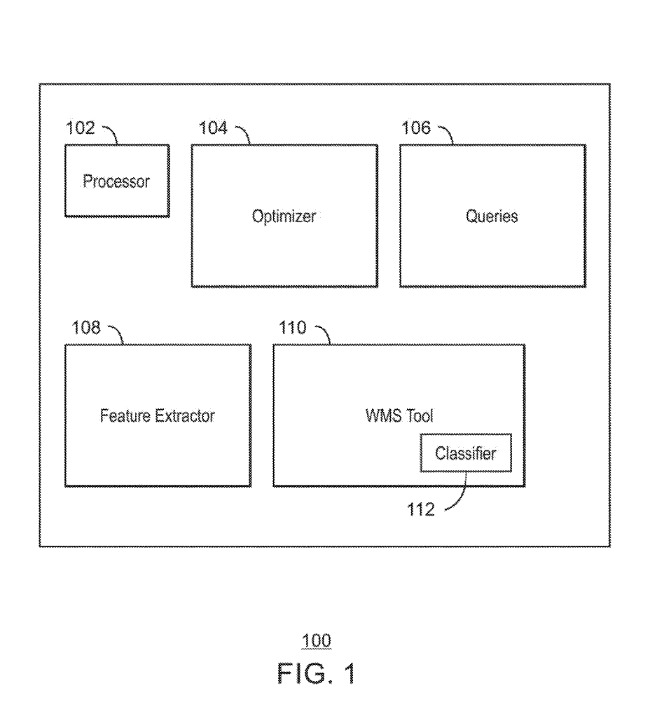

FIG. 1 is a block diagram of an example system 100 for classifying database queries. The system 100 includes a processor 102, a database optimizer 104, queries 106, and a work management system (WMS) 110. The optimizer 104 compiles the queries 106 to produce query plans. Additionally, in the system 100, the optimizer 104 is modified to collect an augmented set of features, which are used in the classification of the queries 106. In one example, the optimizer 104 can recompile a query with different control statements when an anomalous query plan is detected. This can be used to design and test different classes of queries 106. The feature extractor 108 transforms the features collected by the optimizer 104 into features for input to a classifier 112. The WMS 110 is a tool used throughout the industry to manage database systems, and meet QoS goals. Such tools may also help the database administrator to manage various aspects of the system. Additionally, the WMS 110 includes the classifier 112. The classifier 112 characterizes the queries to aid the WMS in making more informed decisions about dispatching queries 106 to the right queues, prioritizing workloads, throttling the system 100 by controlling incoming queries, avoiding queue build-up, and helping deliver on workload service level agreements.

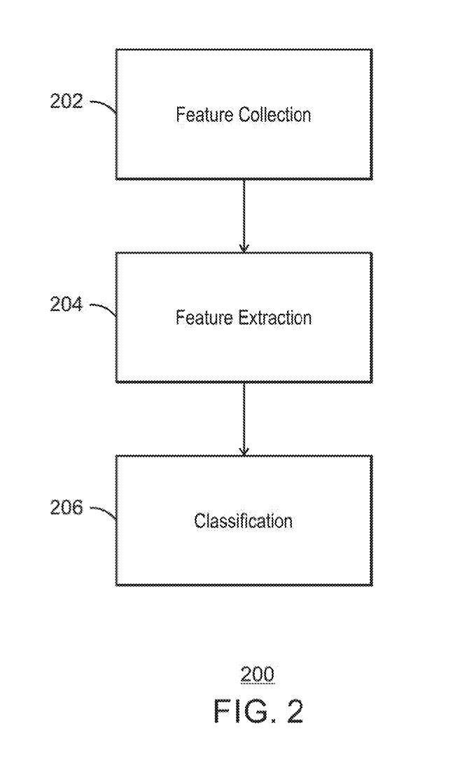

FIG. 2 is a process flow diagram of a method 200 for classifying database queries, according to an example. The method 200 begins at block 202, where query features are collected. Referring also to FIG. 1, as part of producing the query plan, the optimizer 104 collects extensive information about a query 106. This collected information is used to create input features for classification. In general, a number of compile time estimated features of queries 106 are used to classify runtime behavior. In one example, the domain knowledge of a database engineer, such as the DBA, is used to select the features collected by the optimizer 104.

A query plan for a given query is a tree of operators. Thus, features are collected at the query level, as well as the operator level. Some query level features include complexity of the query, total estimated memory, total estimated number of rows read from disk, total estimated number of rows exchanged between processes, missing statistics, total estimated sequential input/outputs (IOs), and total estimated random IOs; although, there are many more. At the operator level, it may be enough to identify a bad pattern. Bad patterns lead to high costs during execution. Thus, a predetermined set of anomalous operators may be identified. These anomalous operators increase the risk of long running times for the query 106. In one example implementation, anomalous operator examples include: a mergejoin with both children sorted; a hash join that does a cross product join; a nested join without predicates on key columns of the scan on the right side; and a hash group-by inside a disk process where memory is limited or memory is at premium.

In an example implementation, about forty features were collected. The features were based on bad plan patterns observed while analyzing different workloads. The selection of features was informed by the domain knowledge of database engineers. The optimizer was modified to collect operator level details of the plan that could be used as the features for classification. For example, for a scan operation, a few exemplary output features include the estimated number of bytes fetched from disk, the estimated number of bytes projected after filtering, and the number of anomalous scans. Anomalous scans are marked by the database engineer based on experiences gained from solving customer escalations.

Another example collection of features is related to detecting existing skew among the data distribution of a predetermined set of SQL table columns. In a parallel plan, the skew may cause a high number of skewed rows to be partitioned to a single process, making the process a bottle-neck, adversely affecting the execution time of the query. The skew in such a scenario may be due to the distribution of data among parallel executing processes during query execution. When such a possible skew is detected by the optimizer, the cited skew imbalance is input to the classification process as a feature. Additional factors include: the total number of anomalous join operators, total estimated CPU usage, estimated number of tuples sent by all operators, and the estimated number of bytes sent by all operators.

At block 204, feature extraction is performed by the feature extractor 108. Feature extraction is the transformation of the features collected by the optimizer 104 into a set of features for classifying the queries 106. The features collected by the optimizer 104 are input to the feature extractor 108. The feature extractor 108 extracts and processes the relevant information and outputs a feature vector for a predetermined set of operators. The feature vectors are created for operators such as the Scan, the Group By, and the Join Operators. The feature extractor 108 also creates a query feature vector. The feature extraction process results in a richer set of attributes than the standard output provided by an optimizer. The output of feature extraction is input to the query classifier 112.

At block 206, the classifier 112 classifies the queries 106 based on the extracted features. In one example, the classification is performed using principles of Machine Learning.

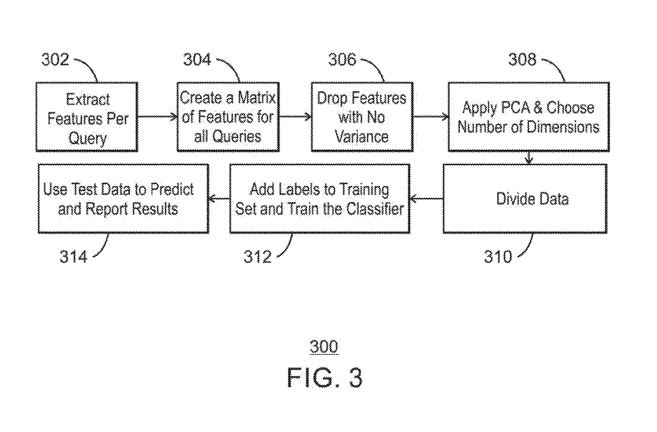

FIG. 3 is a process flow diagram of an example method 300 for classifying queries. At block 302, the features are extracted. This is the same process as described in block 204 with respect to FIG. 2.

At block 304, a matrix is created of features for all queries, such as described with respect to the feature extractor 108 of FIG. 1. The matrix includes the query feature vector, and the feature vectors for each query.

At block 306, features with no variance are dropped from the matrix. The features without variance have no discernible impact on the queries' performance. At block 308, a machine learning method, such as principal component analysis (PCA), may be applied. Additionally, the number of dimensions to be used for a classifier, such as classifier 112 of FIG. 1, is selected. It is noted that PCA is merely used as an example. However, a variety of other machine learning classifications may be used, such as support vector machines (SVM), Naïve Bayes, CART, tree based classifiers, neural network systems and genetic algorithms. The classifier used is independent of the particular implementation. SVMs and CART are supervised learning techniques. Naïve Bayes is a simple model where all features are considered independent. In one example, the number of dimensions is used to explain a threshold variance, such as 85%. At block 310, data to be used to train the classifier is divided up between training, cross validation, and testing sets. The extracted feature data is divided into 3 parts for training the classifier. Training data refers to all estimated features from an optimizer, such as the optimizer 104 of FIG. 1, and the associated labels. Testing data refers to data without the label, e.g., elapsed time. This data is used to determine the effectiveness of the classifier. Cross Validation Data refers to data used to choose parameters in a learning algorithm, such as SVM.

At block 312, the labels are added to the training set. The labels identify the potential classes for the queries. Using these labels, and the divided up data, the classifier is trained. At block 314, the trained classifier is used to predict and report results for classifying queries.

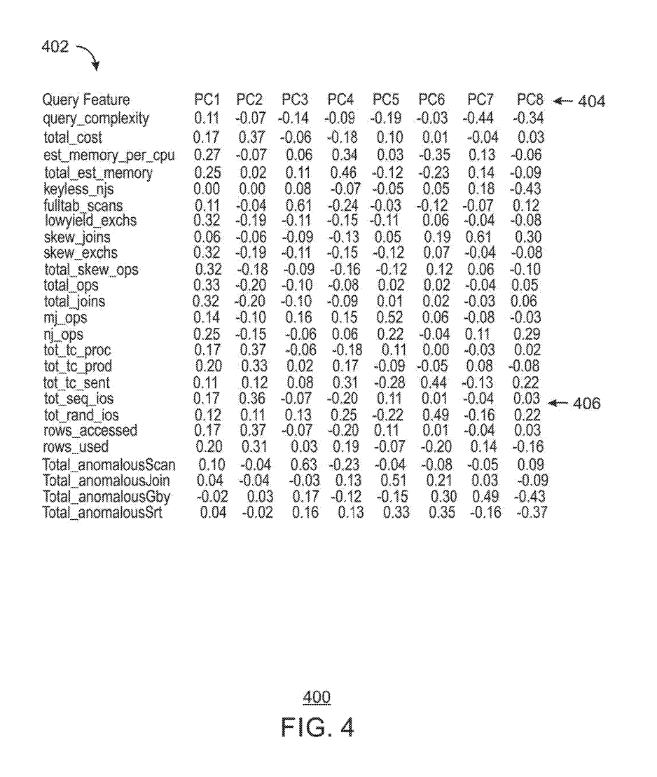

FIG. 4 is a table 400 representing an example of a PCA transformation in eight dimensions. The table 400 shows the loadings of the first eight dimensions of the transformation explaining about 85% of variance in the input features. The table includes dimensions 402 and features 404. Each PCA represents one dimension 402. For example, PC1 accounts for the structure of the query as the feature “total_ops” is one of the most important features in this dimension. In the dimension PC2, features total_cost and the rows_accesses are important ones because they have the largest values. In the dimension PC4, total number of random IOs is important. Any input data can be centered and can be multiplied with the matrix in Table 400 to transform the feature data to the eight dimensions. This transformed data is used for training the classifier 112.

In an example implementation using the example system 100 described with respect to FIG. 1, three thousand SQL queries of varying sizes, where the number of joins ranged from zero to twenty were used. Their elapsed times were used for training purposes. Modification to the optimizer 104 was done to collect useful features. For example, tot_tc_proc represents the summation in bytes of all tuples processed by scan operators; the feature tot_tc_prod stands for summation in bytes of all tuples produced by all scan operators. Similarly, the total number of estimated sequential I/Os and estimated random I/Os is captured in the features tot seq_ios and tot_rand_ios, respectively. Various anomalous operators were also collected. Code was added to the optimizer 104 to indicate an operator is an anomalous based on experiences learned from working customer escalations. When customers try new workloads or migrate to new releases of software, the elapsed times of workloads may vary: For some queries, elapsed query times may be long due to the wrong plan being chosen. The wrong plan may be chosen due to a defect in code or due to a design flaw in the optimizer. Engineers with SQL optimizer expertise may see patterns that could cause the long elapsed times. Higher elapsed times result in customer complaints, and engineers would try to avoid these escalations. In one embodiment, the common patterns are marked as anomalous, and the anomaly is as a feature in the classifier. In some cases, this could also be done during the feature selection process. A number of the full table scans (fulltab_scans above) were also collected. Information on estimated total memory consumption was also collected. All features used were estimates of the optimizer 104, and no runtime information was used, other than the elapsed time which was used in creating the labels for training the classifier 112 using supervised learning algorithms.

Using the R-language, various classifiers were tested to classify the queries 106. The Random Forest classifier and the SVM classifier provided the best results. The collected features were transformed using the PCA and the independent component analysis (ICA) transformations. All the three transformations are examples of unsupervised learning, and were used to reduce variance, or to discover transformations that were statistically independent. The transformed feature data is fed to a supervised classifier, such as SVM or CART.

The results of three experiments are presented, using a workload of about 3,000 queries, varying in complexity from simple scans to 20-way joins. The elapsed times of these queries were collected, as well as the augmented optimizer output. In this example, the query level feature vector consists of about 40 features.

### Experiment 1

A classifier 112 was developed to classify queries 106 into two buckets: normal queries and anomalous queries. The randomly generated training set consisted of about 1,200 queries, and the testing set is randomly drawn from the remaining 1800 queries. A small set was also allocated for cross validation purposes, e.g., for tuning the training parameters in SVM. For the training set, a query was marked as anomalous if the elapsed time exceeded a predefine constant, or if the optimizer 104 marks the query 106 as very expensive, but the actual elapsed time duration is low. Each row of the training set consists of 40 features as well as the predicted “Y” value or the label. The “Y” value is the value being classified across some number of buckets. The classifier predicts where the “Y” value is likely to be placed. To train the classifier, data is collected, that includes the “Y” value label, in addition to the features. All 40 input features were scaled, and had the PCA algorithm applied. Using this approach, the 40 features were reduced to eight dimensions explaining 85% of variance in the data. Using the R language environment, the SVM and the CART classifiers were invoked to develop prediction models. Input rows from the testing set were used to perform the classification using the two models. The results from the two models are shown in Table 1.

TABLE 1
results from the two models.

| Number | F-Score | Accuracy | F-Score | Accuracy |
|---|---|---|---|---|
| of PCA | with | with | with | with |
| Dimensions | SVM | SVM | CART | CART |
| 8 | 0.988814318 | 0.994618 | 0.940639 | 0.972013 |
| 7 | 0.988814318 | 0.994618 | 0.940639 | 0.972013 |
| 6 | 0.979683973 | 0.990312 | 0.896247 | 0.941873 |
| 5 | 0.794258373 | 0.907427 | 0.748768 | 0.886975 |
| 4 | 0.5844022039 | 0.83746 | 0.531017 | 0.796555 |
| 3 | 0.988814318 | 0.994618 | 0.490667 | 0.794403 |
| 2 | 0.979683973 | 0.990312 | 0.609572 | 0.833154 |
| 1 | 0.017621145 | 0.759957 | 0.218182 | 0.768568 |

F-Score is a commonly used metric in the machine learning community; a perfect learner has an F-Score of 1. Accuracy is the sum of True Positives and True Negatives divided by the total population.

### Experiment 2

Using the same workload, but classifying queries among three buckets: first bucket (Class 1) has queries that are quite fast where the elapsed time is less than 0.01 seconds. The third bucket (Class 3) consists of anomalous queries, as described above. The second bucket (Class 2) consists of the rest of the workload. With a randomly drawn training data set of 1,300 queries, a Random Forest of trees model was trained using the package “RandomForest” in the R language environment. With a randomly generated training set from the remaining 1,700 queries, the model was tested. The preliminary results are shown in Table 2, in the form of an accuracy table, where the rows are the actual results, and the columns are the predictions.

TABLE 2
An accuracy table showing
results from Experiment 2.

| CLASS | 1 | 2 | 3 |
|---|---|---|---|
| 1 | 0.961165049 | 0.29126214 | 0.009709 |
| 2 | 0.032945736 | 0.877906977 | 0.089147 |
| 3 | 0.019323671 | 0.183754879 | 0.797101 |

For example, the item in cell (1,1) shows that of all queries 106 that are in class 1 (actuals), 96% are classified as class 1 (predictions); the item in cell (2,3) shows that of all queries that are in class 3 (actuals), 8% are classified as class 2 (predictions). The values on the major diagonal are correctly predicted numbers divided by actuals. Values in other cells represent errors in the prediction.

### Experiment 3

In this experiment, ICA was used for the transformation and the SVM and the Random Forest packages were applied to the query features. ICA is another popular transformation tool for transforming data to learn about main components. In addition to PCA, the input data was also tested by converting it into statistically independent components using the ICA transformation. The performance of the PCA transformation was compared with that of the ICA transformation. A cross fold validation method was used by training models using random subsets of data repeatedly as follows: divide the input data into two random sets: a training set, and q testing set. The training set is randomly chosen to be 80% of the data, and the remaining 20% is testing data. The results are shown in Table 3.

TABLE 3
Results from Experiment 3

| METHOD | RANDOM FOREST | | | | SVM | | | |
|---|---|---|---|---|---|---|---|---|
| | Pre- | | | | Pre- | | | |
| | dicted/ | | | | dicted/ | | | |
| PCA | Truth | 1 | 2 | 3 | Truth | 1 | 2 | 3 |
| | 1 | 1,337 | 118 | 27 | 1 | 1,298 | 66 | 35 |
| | 2 | 81 | 2,941 | 278 | 2 | 103 | 2,976 | 409 |
| | 3 | 16 | 236 | 1,156 | 3 | 33 | 253 | 1,017 |
| | Pre- | | | | Pre- | | | |
| | dicted/ | | | | dicted/ | | | |
| ICA | Truth | 1 | 2 | 3 | Truth | 1 | 2 | 3 |
| | 1 | 1,235 | 105 | 20 | 1 | 1,341 | 61 | 37 |
| | 2 | 165 | 2,824 | 484 | 2 | 107 | 2,883 | 410 |
| | 3 | 74 | 277 | 1,006 | 3 | 26 | 262 | 1,063 |

These are averages over a 10-way run. They show that the Random Forest package works well for the example workload. However, the SVM used with ICA also shows promise.

In these examples, classification is based on expected query execution times. However, one could use different criteria for classification. For example, the classification could be based on the type of SQL operator that uses the most resources during execution of the SQL query, i.e., the dominant operator. For example, the possible classifications may include the JOIN operator types, the GROUPBY operator, and the parallelization operator. Such a classification could be useful to a QA engineer in designing a coverage test, or running relevant tests prior to a release. By classifying queries in this way, a coverage test may test the various types of data accesses performed by a system, instead of testing every single query. If there are thousands of queries to test, but there is a time limitation, then the classification on the dominant SQL operator may be used to design a test suite that tests a minimal set of queries satisfying the time limitation.

Alternatively, the dominant operator, or operators, may be used as features in this, or another, classification scheme. For example, classification according to timeout thresholds may be based on the top two dominant operator types in a query.

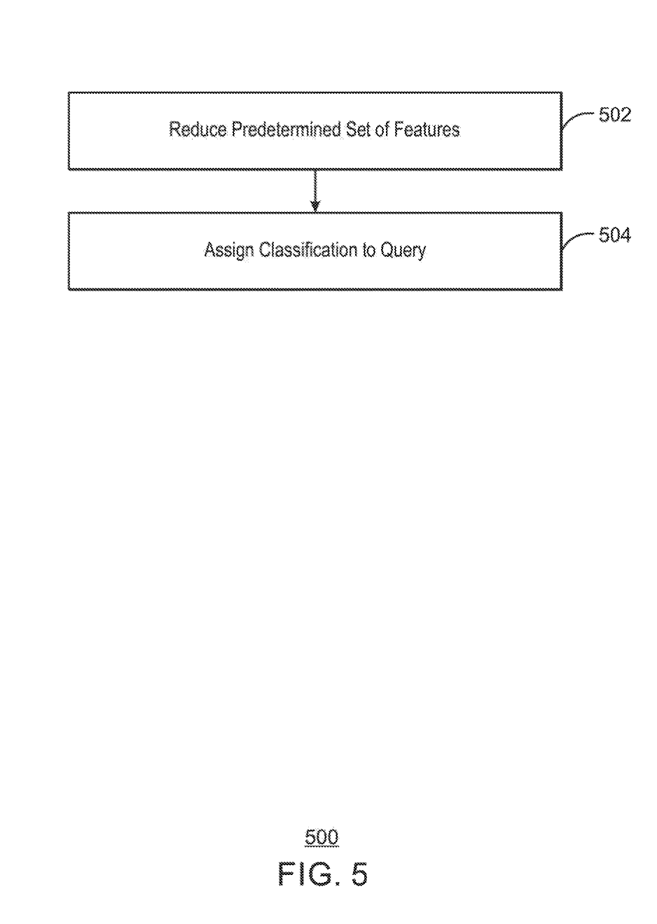

FIG. 5 is a process flow diagram of a method 500 for database query classification. The method 500 begins at block 502, where a predetermined set of features, generated by an optimizer, is reduced to a learned model of features by using a machine learning method. Classification is performed based on features of the query and features of operators executed by the query. At block 504, an execution classification is assigned to a query based on the learned model of features. The execution classification is associated with a pre-defined threshold for execution of the query.

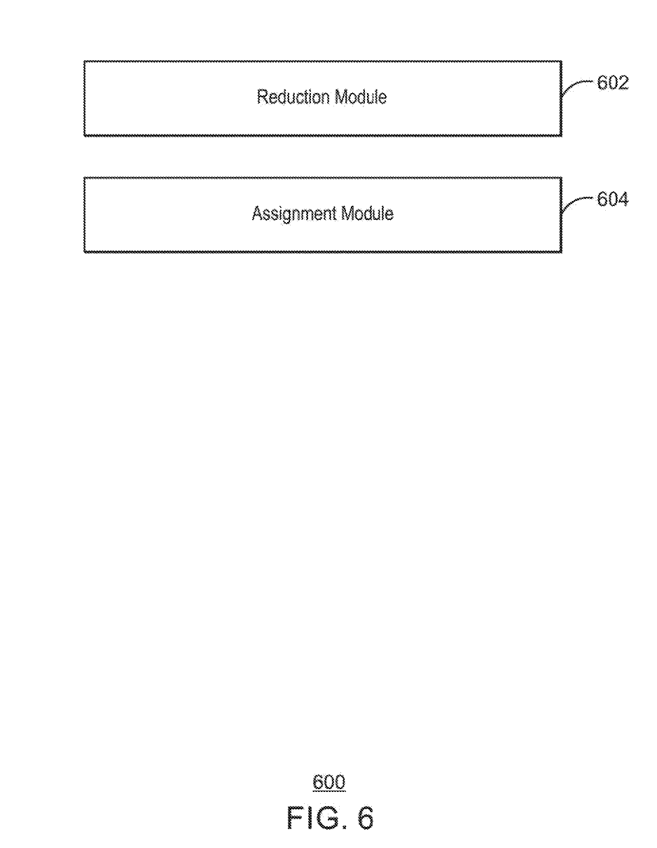

FIG. 6 is a block diagram of an example system 600 for database query classification. The system 600 includes a reduction module 602 and an assignment module 604. The reduction module 602 reduces the predetermined set of features generated by the optimizer to a learned model of features by using a machine learning method. The assignment module 604 assigns an execution classification to a query based on the learned model of features.

Each module 602, 604 may be electronic circuitry (i.e., hardware) that implements the functionality of the module. Each module may also include instructions (e.g., stored on a machine-readable storage medium of the system) that, when executed (e.g., by a processor of system), offer the functionality of the module.

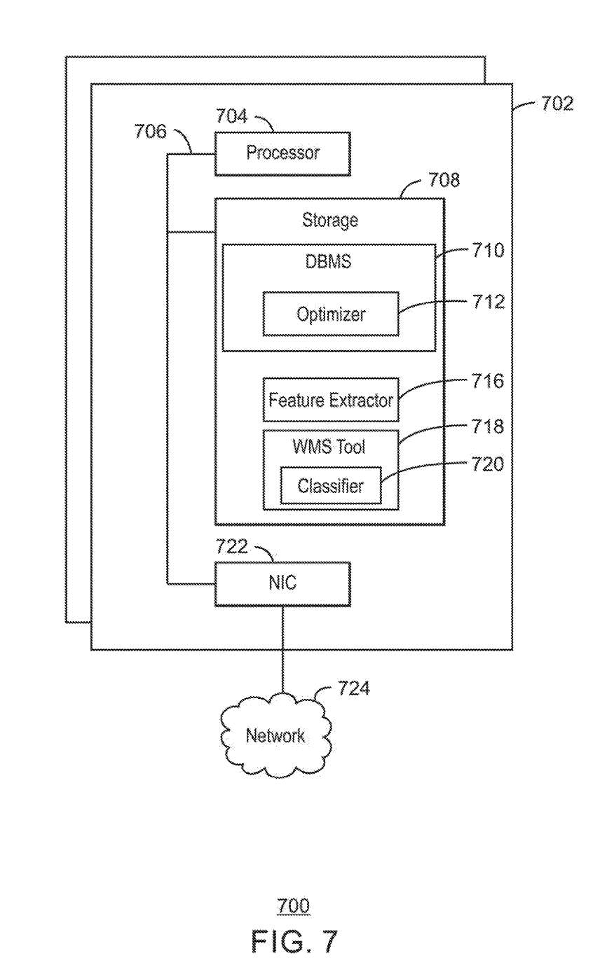

FIG. 7 is a block diagram of an example system 700 for database query classification, in accordance with an example. The functional blocks and devices shown in FIG. 7 may include hardware elements including circuitry, software elements including computer code stored on a tangible, non-transitory, machine-readable medium, or a combination of both hardware and software elements. Additionally, the functional blocks and devices of the system 700 are but one example of functional blocks and devices that may be implemented in examples. The system 700 can include any number of computing devices, such as computers, servers, laptop computers, or other computing devices.

The example system 700 can include clusters of database servers 702 having one or more processors 704 connected through a bus 706 to a storage 708. The storage 708 is a tangible, computer-readable media for the storage of operating software, data, and programs, such as a hard drive or system memory. The storage 708 may include, for example, a basic input output system (BIOS) (not shown).

In an example, the storage 708 includes a DBMS 710, which includes an optimizer 712. The storage 708 also includes a feature extractor 716, and a WMS tool 718, which includes a classifier 720. The server 702 can be connected through the bus 706 to a network interface card (NIC) 722. The NIC 722 can connect the database server 702 to a network 724 that connects the servers 702 of a cluster to various clients (not shown) that provide the queries. The network 724 may be a local area network (LAN), a wide area network (WAN), or another network configuration. The network 724 may include routers, switches, modems, or any other kind of interface devices used for interconnection. Further, the network 724 may include the Internet or a corporate network.

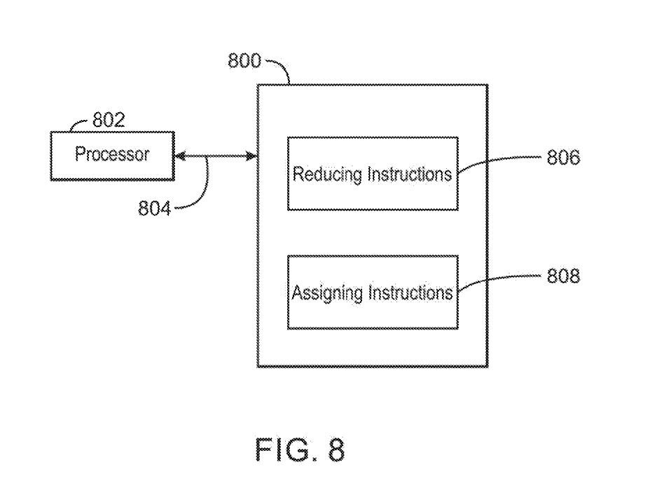

FIG. 8 is a block diagram showing an example tangible, non-transitory, machine-readable medium 800 that stores code for database query classification, according to an example. The machine-readable medium is generally referred to by the reference number 800. The machine-readable medium 800 may correspond to any typical storage device that stores computer-implemented instructions, such as programming code or the like. Moreover, the machine-readable medium 800 may be included in the storage 708 shown in FIG. 7. The machine-readable medium 800 includes reducing instructions 806 that reducing instructions that reduce a predetermined plurality of features, generated by an optimizer, to a learned model of features by using a machine learning method, wherein classification is performed based on features of a query and features of operators executed by the query. The assigning instructions 808 assign an execution classification to a query based on the learned model of features, the execution classification being associated with a timeout threshold for execution of the query.

A predetermined plurality of features, generated by an optimizer, is reduced to a leaned model of features by using a machine learning method. Classification is performed based on features of the query and features of operators executed by the query. An execution classification is assigned to a query based on the learned model of features. The execution classification is associated with a pre-defined threshold for execution of the query.

What is claimed is:

1. A method for improving database query classification, comprising:
reducing a predetermined plurality of features, generated by an optimizer, to a learned model of features by using a machine learning method, wherein classification is performed based on features of the query and features of operators executed by the query; and
assigning an execution classification to a query based on the learned model of features.

2. The method of claim 1, wherein the predetermined plurality of features identify a bad pattern of data access.

3. The method of claim 1, wherein the predetermined plurality of features identify a skew of data to one process of a parallel execution.

4. The method of claims 1-3, comprising identifying, by the optimizer, an anomalous query.

5. The method of claim 4, comprising recompiling the anomalous query using a different set of control statements based on identifying the anomalous query.

6. The method of claim 5, comprising determining that a node of a query plan generated by the optimizer is anomalous.

7. The method of claim 6, wherein identifying the anomalous query comprises determining that one or more nodes of the query is anomalous.

8. The method of claim 6, wherein the anomalous query may be identified as anomalous by the classifier based on behavior of classifier even if none of the nodes are anomalous.

9. The method of claim 1, the execution classification being associated with a timeout threshold for execution of the query.

10. The method of claim 1, the execution classification being associated with a dominant operator of the query.

11. A system, comprising:
a reduction module that reduces a predetermined plurality of features, generated by an optimizer, to a learned model of features by using a machine learning method, wherein classification is performed based on features of a query and features of operators executed by the query; and
an assignment module that assigns an execution classification to a query based on the learned model of features, the execution classification being associated with a timeout threshold for execution of the query.

12. The system of claim 11, wherein the predetermined plurality of features identify a bad pattern of data access.

13. The system of claim 11, wherein the predetermined plurality of features identify a skew of data to one process of a parallel execution.

14. The system of claims 11-13, comprising computer-implemented instructions to identify, by the optimizer, an anomalous query.

15. A tangible, non-transitory, computer-readable medium comprising:
reducing instructions that reduce a predetermined plurality of features, generated by an optimizer, to a learned model of features by using a machine learning method, wherein classification is performed based on features of a query and features of operators executed by the query; and
assigning instructions that assign an execution classification to a query based on the learned model of features, the execution classification being associated with a timeout threshold for execution of the query.
